(19) United States
(12) Patent Application Publication
(10) Pub. No.: US 2026/0235082 A1
(43) Pub. Date: Aug. 13, 2026

(54) ELECTRIC THROTTLE DEVICE

(71) Applicant: AISAN KOGYO KABUSHIKI KAISHA, Obu-shi (JP)

(72) Inventors: Toshihide KOKUBU, Obu-shi (JP); Yuto NARITA, Kariya-shi (JP); Eisuke BABA, Kasugai-shi (JP)

(73) Assignee: AISAN KOGYO KABUSHIKI KAISHA, Obu-shi (JP)

(21) Appl. No.: 19/460,637

(22) Filed: Jan. 27, 2026

(30) Foreign Application Priority Data
Feb. 10, 2025 (JP) 2025-019911

(51) Int. Cl. F02D 9/10

(52) U.S. Cl. CPC F02D 9/10

(57) ABSTRACT

An electric throttle device for a naturally aspirated gasoline engine is provided. The device includes a throttle body defining an intake passage, a throttle valve fixed to a valve shaft, a closing spring applying a closing-direction torque according to an opening degree θ, and an electric motor driving the throttle valve through a reduction gear mechanism. The closing spring is configured such that a closing-side holding limit torque G exceeds a sum of a vacuum-induced torque T(θ) and an elastic torque S(θ). The vacuum-induced torque T(θ) is generated by negative pressure produced when the engine is assumed to operate at maximum intake air flow. The elastic torque S(θ) is generated by the closing spring. The closing-side holding limit torque G is defined as a minimum torque capable of rotating the throttle valve in the closing direction when stationary, without intake air flow, without the closing spring, and with the motor de-energized.

### CROSS-REFERENCE TO RELATED APPLICATIONS

This application claims priority to Japanese patent application serial number 2025-019911 filed Feb. 10, 2025, which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to electric throttle devices.

Vehicles equipped with internal combustion engines, such as gasoline engines, typically include an electric throttle device installed in the intake passage. The electric throttle device is equipped with a throttle valve for controlling the intake air flow through the intake passage. The electric throttle device is configured such that the opening degree of the throttle valve frequently changes in response to the user's operation of the accelerator pedal. Furthermore, when power to the electric throttle device is interrupted, for example, due to a malfunction, a spring attached to the throttle valve forcibly changes the throttle valve to an emergency position that enables escape driving (driving at a slow speed). Therefore, to keep the throttle valve of the electric throttle device at an opening different from the emergency position, power must be continuously supplied to the electric throttle device.

On the other hand, in the case of a generator, the throttle valve opening of an electric throttle device installed in the intake passage of a gasoline engine is maintained at a substantially constant opening during operation of the gasoline engine. Therefore, in a power generation system utilizing a gasoline engine as a generator, it is desirable that the throttle valve opening can be maintained at its current position when power supply to the electric throttle device is stopped, in order to reduce the power required to maintain the throttle valve opening at a predetermined position. Therefore, there is a need for an improved electric throttle device that can stably maintain the throttle valve opening at the time when the electric power supply is stopped and reduce power consumption.

### SUMMARY OF THE INVENTION

In one aspect of this disclosure, an electric throttle device is configured to be provided in an intake passage of a naturally aspirated gasoline engine. The electric throttle device comprises a throttle valve, a closing spring that applies a torque to the throttle valve in a closing direction depending on an opening degree of the throttle valve from a fully closed position, and an electric motor that rotates the throttle valve between the fully closed position and a fully open position. The closing spring satisfies G>T(θ)+S(θ) in the closing direction. T(θ) is a vacuum-induced torque that acts on the throttle valve at the opening degree θ in the closing direction. The vacuum-induced torque is generated by a negative pressure caused by an assumed maximum intake air flow during operation of a gasoline engine. S(θ) is an elastic torque that acts on the throttle valve at the opening degree θ in the closing direction. The elastic torque is generated by the closing spring. G is a closing-side holding limit torque that is a minimum torque capable of rotating the throttle valve, when stationary, in the closing direction regardless of the opening degree of the throttle valve in a state where there is no air flow in the intake passage, the closing spring is not mounted, and the electric motor is not energized.

### BRIEF DESCRIPTION OF THE DRAWINGS

FIG. 1 is a front view of an embodiment of an electric throttle device, with a cover shown in phantom to illustrate the internal mechanism.

FIG. 2 is a side view of the electric throttle device, viewed along the arrow A in FIG. 1.

FIG. 3 is a cross-sectional view of the electric throttle device taken along the line III-III in FIG. 2.

FIG. 4 is a diagram illustrating the vacuum-induced torque T(θ) acting in the closing direction on the throttle valve at opening degree θ, where the throttle valve is in the fully closed position (A), between the fully closed position and the fully open position (B), and in the fully open position (C).

FIG. 5 is a graph illustrating a relationship between the torque applied to the throttle valve and the throttle valve opening in the electric throttle device equipped with a closing spring.

FIG. 6 is a graph illustrating a relationship between the torque applied to the throttle valve and the throttle valve opening in the electric throttle device equipped with an opening spring.

### DETAILED DESCRIPTION

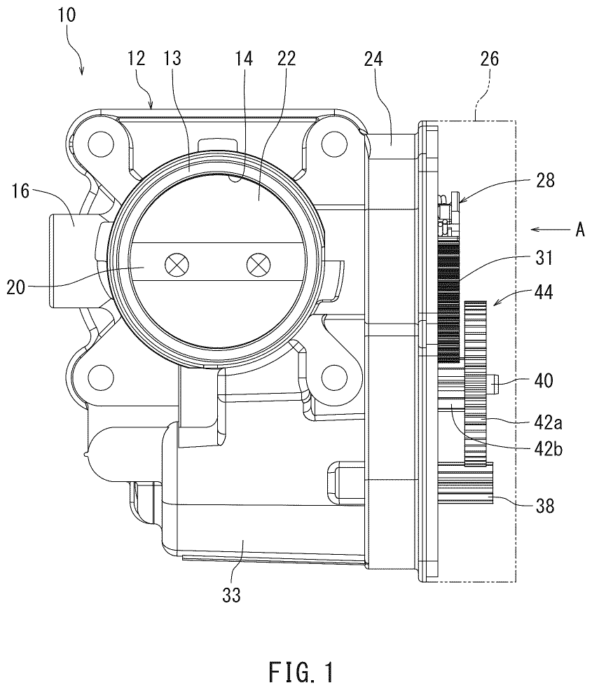

The overall structure of an electric throttle device 10 will be described with reference to FIGS. 1 to 3. In this embodiment, the electric throttle device 10 is configured to be installed in the intake passage of a naturally aspirated gasoline engine (hereinafter referred to as the “engine”) used in a power generation system. The electric throttle device 10 controls the intake air flow rate (the engine's intake air flow rate) by adjusting the opening degree of the intake passage.

As shown in FIG. 1, the electric throttle device 10 includes a throttle body 12, which may, for example, be made of resin. The throttle body 12 has a hollow cylindrical bore wall portion 13 and an intake passage 14 that is formed by the hollow portion of the bore wall portion 13. The intake passage 14 is in fluid communication with the intake system of the engine (not shown).

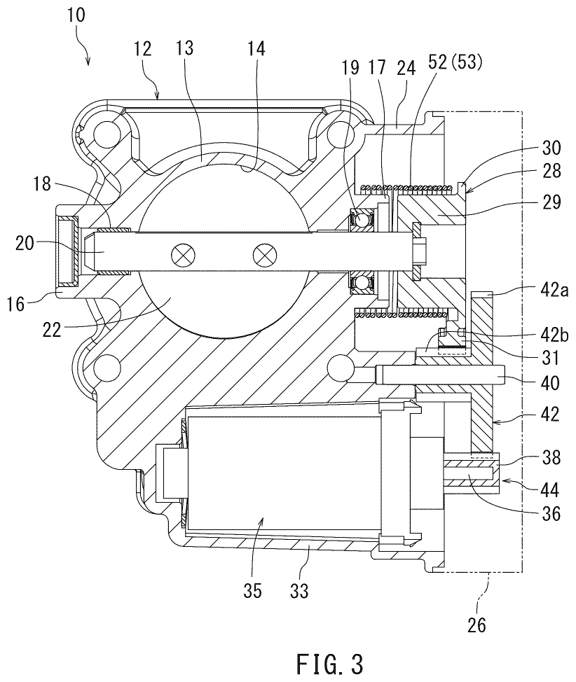

As shown in FIG. 3, boss portions 16 and 17 are formed coaxially on both radial sides of the bore wall portion 13. The boss portions 16 and 17 rotatably support a valve shaft 20, which traverses the intake passage 14 radially, via bearings 18 and 19. The valve shaft 20 is provided with a butterfly-type throttle valve 22 having a circular plate shape. The throttle valve 22 rotates integrally with the valve shaft 20 to open and close the intake passage 14, thereby controlling the amount of air intake into the engine.

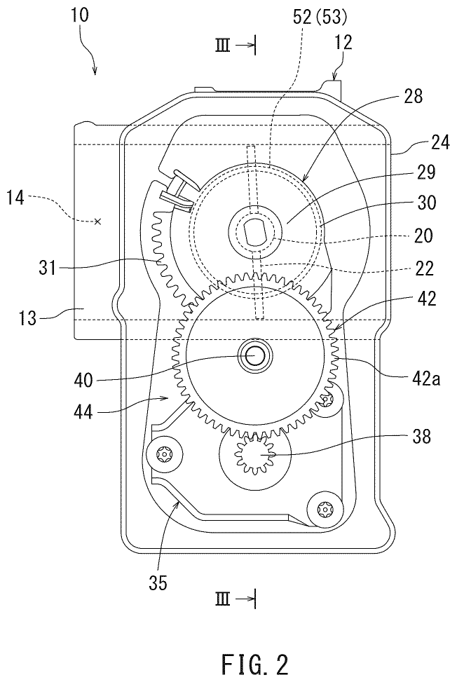

An annular gear housing portion 24 is formed along the outer periphery of one side (the right side in FIG. 3) of the throttle body 12. The open end of the gear housing portion 24 is closed by a cover 26, which may, for example, be made of resin. In FIG. 1, the cover 26 is shown in phantom (dotted line) to reveal the internal gear mechanism, whereas in FIG. 2, the cover 26 is omitted. On the side of the gear housing portion 24, the tip of the valve shaft 20 protrudes beyond the boss portion 17 and is fixed to a throttle gear 28, which may, for example, be made of resin. The throttle gear 28 comprises a hollow cylindrical gear body portion 29, an annular flange portion 30, and a gear portion 31. The flange portion 30 is formed on the gear body portion 29 and is located on the opposite side of the boss portion 17. The gear portion 31 has a circular sector shape on the outer periphery of the flange portion 30. The gear body portion 29 faces the boss portion 17 of the throttle body 12 and has the rotational axis that is coaxial with the rotational axis of the boss portion 17. The gear body portion 29 has the outer diameter substantially identical to the outer diameter of the boss portion 17 of the throttle body 12.

The throttle body 12 has a cylindrical motor housing portion 33 formed therein. The motor housing portion 33 has a closed end and an open end that opens into the gear housing portion 24. The motor housing portion 33 houses an electric motor 35, such as a DC motor. The electric motor 35 has an output shaft 36 that protrudes toward the opening side of the gear housing portion 24. The output shaft 36 is integrally provided with a pinion gear 38 so as to be rotatable therewith. The electric motor 35 is controlled by a control device (not shown) that controls the engine of the power generation system.

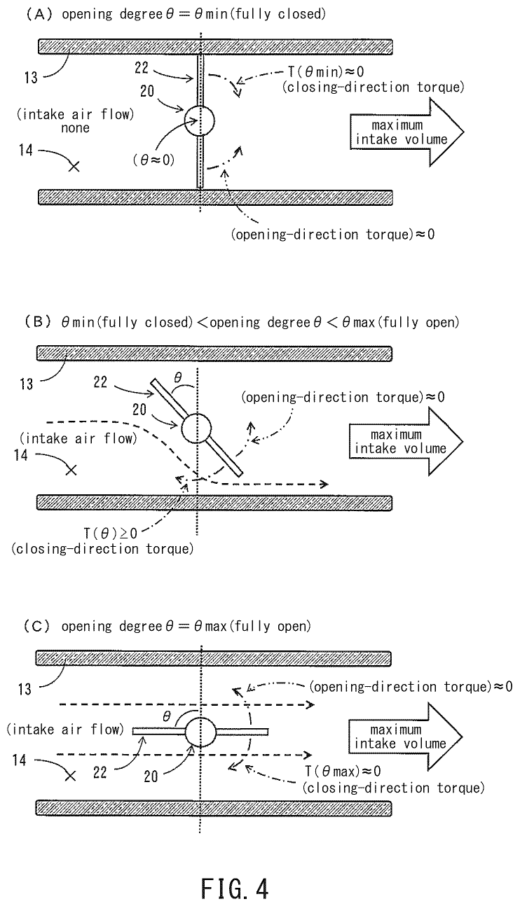

As shown in FIGS. 2 and 3, a counter shaft 40 is fixed to the side surface of the throttle body 12 on the gear housing portion 24 side. The counter shaft 40 may be made of resin and is arranged parallel between the valve shaft 20 and the output shaft 36 of the electric motor 35. The counter shaft 40 rotatably supports a counter gear 42, for example made of resin. The counter gear 42 has a large-diameter gear portion 42a and a small-diameter gear portion 42b with different diameters arranged coaxially. The large-diameter gear portion 42a meshes with the pinion gear 38. The small-diameter gear portion 42b meshes with the gear portion 31 of the throttle gear 28. When the electric motor 35 rotates the output shaft 36 in the forward or reverse direction, the rotational force of the output shaft 36 is transmitted to the throttle gear 28 via the pinion gear 38 and the counter gear 42, causing the valve shaft 20 to rotate. By this, the electric motor 35 can rotate the throttle valve 22 attached to the valve shaft 20 between the fully closed position (see position (A) in FIG. 4) and the fully open position (see position (C) in FIG. 4) for controlling the opening degree of the intake passage 14. As shown in FIGS. 2 and 3, a reduction gear mechanism 44 is formed from the pinion gear 38, the counter gear 42, and the throttle gear 28.

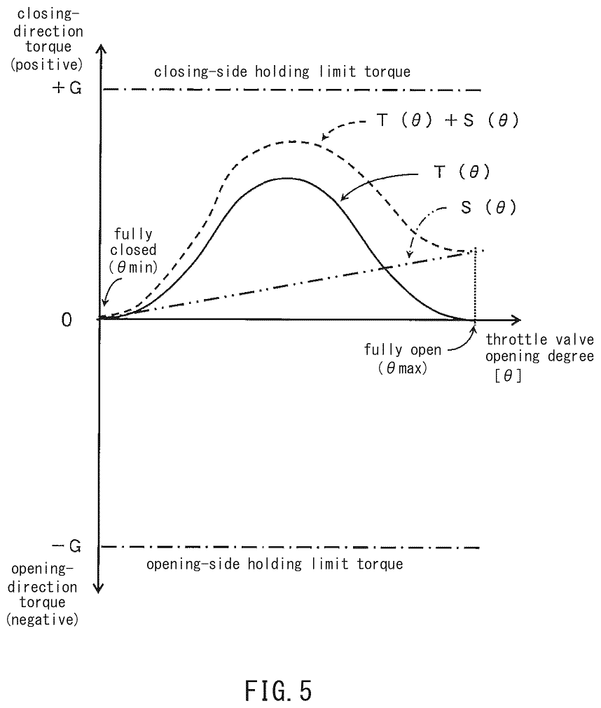

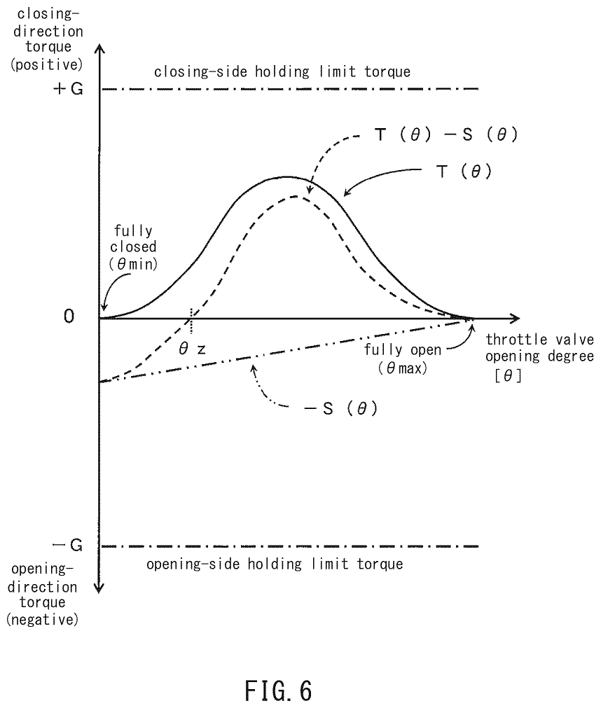

One of a closing spring 52 and an opening spring 53 is provided on the outer peripheries of the boss portion 17 and the gear body portion 29. When the closing spring 52 is provided, the closing spring 52 applies a closing-direction torque to the throttle valve 22 depending on the opening degree from the fully closed position of the throttle valve 22 (see elastic torque S(θ) in FIG. 5). When the opening spring 53 is provided, the opening spring 53 applies an opening-direction torque to the throttle valve 22 depending on the closing degree from the fully open position of the throttle valve 22 (see elastic torque −S(θ) in FIG. 6). In other words, the opening-direction torque of the opening spring 53 changes depending on the opening degree from the fully closed position of the throttle valve 22. Hereinafter, the closing-direction torque applied to the throttle valve 22 is also referred to as positive torque (≥0), and the opening-direction torque is also referred to as negative torque (<0) (see FIGS. 4, 5, and 6).

An electric throttle device for a vehicle equipped with an engine forcibly changes the throttle valve to an emergency position that enables the escape driving when power is cut off during abnormal conditions. Therefore, in the electric throttle device for the vehicle, power must be continuously supplied to the electric throttle device to keep the throttle valve at an opening different from the emergency position.

In this embodiment, the engine is used for the generator. Therefore, it is not necessary to forcibly change the throttle valve to the emergency position when power supply is stopped during abnormal conditions. Although the explanation is omitted, safe stopping is achieved by means other than the throttle valve control during abnormal conditions. Furthermore, during operation of an engine used for a generator, the throttle valve opening is nearly constant. Therefore, maintaining the throttle valve opening after power to the electric throttle device is shut off allows power consumption to be reduced, which is desirable.

Next, the vacuum-induced torque acting on the throttle valve 22, generated by the intake air flow of the operating engine, will be explained with reference to FIG. 4. The intake air flow rate of the operating engine varies significantly depending on the operating condition. However, to take into account the maximum vacuum-induced torque, it is assumed that the throttle valve 22 is subjected to the vacuum-induced torque generated by the intake air flow at the engine's maximum intake air flow rate. The engine is a naturally aspirated gasoline engine. Positions (A) to (C) in FIG. 4 illustrate the intake air flow when the engine (not shown) draws air at maximum intake air flow rate from the right side of the intake passage 14. The assumed maximum intake air flow rate is, for example, the intake air flow rate when the throttle valve 22 is fully open and the engine is operating at maximum rotational speed.

In FIG. 4, position (A) illustrates the case where the opening degree θ of the throttle valve 22 is minimum (i.e., θmin≈0 degrees), representing the fully closed state. In this case, no intake air flows from the upstream side of the throttle valve 22 to its downstream side within the intake passage 14. Therefore, the vacuum-induced torque T(θmin) applied to the throttle valve 22 in the closing direction due to the intake air flow is essentially zero. The opening-direction torque is also essentially zero.

In FIG. 4, position (B) illustrates the case where the opening degree θ of the throttle valve 22 is between minimum and maximum, i.e., in the range θmin (fully closed)<θ<θmax (fully open). θmin (fully closed) is approximately equal to 0 degrees (see FIG. (A)), and θmax (fully open) is approximately equal to 90 degrees (see FIG. 4, position (C)). In this case, intake air flows from the upstream side of the throttle valve 22 to its downstream side within the intake passage 14, as shown by the dotted line. The negative pressure generated by this airflow creates a vacuum-induced torque T(θ) acting on the throttle valve 22 at the opening degree θ in the closing direction. The opening-direction torque is essentially zero. When the engine is drawing in the maximum intake air flow rate, the vacuum-induced torque T(θ) exhibits the characteristics shown in FIGS. 5 and 6, depending on the opening degree θ of the throttle valve 22.

In FIG. 4, position (C) illustrates the case where the opening degree θ of the throttle valve 22 is maximum (i.e., θmax≈90 degrees), representing the fully open state. In this case, the intake air flows from the upstream side of the throttle valve 22 to its downstream side within the intake passage 14, as shown by the dotted line. Therefore, the vacuum-induced torque T(θmax) applied to the throttle valve 22 in the closing direction due to this air flow is nearly zero. The opening-direction torque is also nearly zero.

FIG. 5 illustrates a relationship between the torque applied to the throttle valve 22 and the throttle valve opening in the case where the electric throttle device 10 is equipped with the closing spring 52. FIG. 5 shows the throttle valve opening degree θ on the horizontal axis, the closing-direction (positive) torque on the upward vertical axis, and the opening-direction (negative) torque on the downward vertical axis.

FIG. 5 illustrates that the closing-direction vacuum-induced torque T(θ), which acts on the throttle valve 22 at the opening degree θ and is generated by the negative pressure caused by the airflow corresponding to the maximum intake air flow rate for the engine during operation, is greater than or equal to 0 (≥0).

FIG. 5 also shows that the closing-direction elastic torque S(θ) applied to the throttle valve 22 at the opening degree θ by the closing spring 52 is greater than or equal to 0 (≥0). The torques acting on the throttle valve 22 are the aforementioned T(θ) and S(θ), in other words, the composite torque T(θ) +S(θ) acts on the throttle valve 22.

FIG. 5 illustrates the closing-side holding limit torque G (≥0) that is the minimum torque capable of rotating the stationary throttle valve 22 in the closing direction, regardless of opening degree of the throttle valve 22, in a state where there is no flow of intake air within the intake passage 14, no closing spring 52 is provided on the electric throttle device 10, and power is not supplied to the electric motor 35. Furthermore, the minimum torque capable of rotating the stationary throttle valve 22 in the opening direction is defined as the opening side holding limit torque −G (<0) in FIG. 5. The closing-side holding limit torque (G) and the opening-side holding limit torque (−G) are determined by the detent torque of the electric motor 35 when de-energized, sliding resistance from components such as the throttle gear 28, the counter gear 42, the pinion gear 38, and the bearings 18, 19, etc.

As shown in FIG. 5, in the case of the electric throttle device 10 equipped with the closing spring 52, when the opening degree θ of the throttle valve 22 is between the fully closed state (θmin) and the fully open state (θmax), T(θ)+S(θ) is non-negative (≥0).

As shown in FIG. 5, in the range of the throttle valve opening degree θ from the fully closed state (θmin) to the fully open state (θmax), if the closing spring 52 having a spring constant that satisfies G>T(θ)+S(θ) in the closing direction is mounted on the electric throttle device 10, the opening degree of the throttle valve 22 at that time when the electric motor 35 is not energized can be stably maintained. Furthermore, since the closing spring 52 constantly biases the throttle valve 22 in the closing direction, there is no rattling, such as minute vibrations, caused by gear backlash, and hunting of the throttle valve 22 is avoided, so that the opening degree of the throttle valve 22 can be stably maintained.

FIG. 6 illustrates a relationship between the torque applied to the throttle valve 22 and the throttle valve opening in the case where the electric throttle device 10 is equipped with the opening spring 53. FIG. 6 shows the throttle valve opening degree θ on the horizontal axis, the closing-direction (positive) torque on the upward vertical axis, and the opening-direction (negative) torque on the downward vertical axis.

FIG. 6 shows that the closing-direction vacuum-induced torque T(θ), which acts on the throttle valve 22 at the opening degree θ and is generated by the negative pressure caused by the airflow corresponding to the maximum intake air flow rate for the engine during operation, is greater than or equal to 0 (≥0). The closing-direction vacuum-induced torque T(θ) in the case of FIG. 6 is the same as the closing-direction vacuum-induced torque T(θ) in the case of FIG. 5.

FIG. 6 also shows that the opening-direction elastic torque −S(θ) applied to the throttle valve 22 at opening degree θ by the opening spring 53 is less than 0 (<0). The torques acting on the throttle valve 22 are T(θ) and −S(θ), in other words, the composite torque T(θ)−S(θ) acts on the throttle valve 22.

FIG. 6 illustrates the closing-side holding limit torque G (≥0) that is the minimum torque capable of rotating the stationary throttle valve 22 in the closing direction, regardless of opening degree of the throttle valve 22, in a state where there is no flow of intake air within the intake passage 14, no opening spring 53 is mounted on the electric throttle device 10, and power is not supplied to the electric motor 35. Furthermore, the minimum torque capable of rotating the stationary throttle valve 22 in the opening direction is defined as the opening side holding limit torque −G (<0) in FIG. 6. The closing-side holding limit torque (G) and the opening-side holding limit torque (−G) are determined by the detent torque of the electric motor 35 when de-energized, sliding resistance from components such as the throttle gear 28, the counter gear 42, the pinion gear 38, and the bearings 18, 19, etc.

As shown in FIG. 6, in the case where the electric throttle device 10 is equipped with the opening spring 53, T(θ)−S(θ) is negative (<0) in the range θmin (fully closed)≤θ<θz, and non-negative (≥0) in the range θz≤θ≤θmax (fully open).

From FIG. 6, it can be seen that, if an opening spring 53 having a spring constant that satisfies G>T(θ)−S(θ) in the closing direction and |−G|>|T(θ)−S(θ)|in the opening direction in the range of the throttle valve opening degree θ from the fully closed state (θmin) to the fully open state (θmax) is mounted on the electric throttle device 10, the opening degree of the throttle valve 22 at the time when the electric motor 35 is not energized can be stably maintained. In the case shown in FIG. 6, it is sufficient to use an opening spring 53 with a spring constant satisfying G>T(θ)−S(θ) when T(θ)−S(θ) is non-negative (≥0), i.e., in the range θz≤θ≤θmax, and satisfying |−G|>|T(θ)−S(θ) (<0)| when T(θ)−S(θ) is negative (<0), i.e., in the range θmin≤θ<θz. Furthermore, since the opening spring 53 constantly biases the throttle valve 22 in the opening direction, there is no rattling, such as minute vibrations, caused by gear backlash, and hunting of the throttle valve 22 is avoided, so that the opening degree of the throttle valve 22 can be stably maintained.

Therefore, by installing the closing spring 52 or the opening spring 53 with an appropriate spring constant on the electric throttle device 10 that is provided in the intake passage of the naturally aspirated gasoline engine, the opening degree of the throttle valve 22 at the time when power to the electric motor 35 is stopped can be stably maintained. Consequently, power consumption can be reduced.

The technique disclosed herein can be changed or modified without departing from the spirit or scope of the invention. For example, the electric throttle device 10 is not limited to use in a power generation system equipped with a naturally aspirated gasoline engine, but can be applied to various systems using a naturally aspirated gasoline engine.

The present disclosure includes various aspects as follows. A first aspect is an electric throttle device provided in an intake passage of a naturally aspirated gasoline engine. The electric throttle device comprises a throttle valve, a closing spring that applies a torque to the throttle valve in a closing direction depending on an opening degree from a fully closed position, and an electric motor that rotates the throttle valve between the fully closed position and a fully open position. The closing spring satisfies G>T(θ)+S(θ) in the closing direction. T(θ) is a vacuum-induced torque acting on the throttle valve at the opening degree θ in the closing direction. The vacuum-induced torque is produced by a negative pressure generated when the naturally aspirated gasoline engine is assumed to operate at its maximum intake air flow. S(θ) is an elastic torque acting on the throttle valve at the opening degree θ in the closing direction. The elastic torque is generated by the closing spring. G is a closing-side holding limit torque that is a minimum torque capable of rotating the throttle valve, when stationary, in the closing direction regardless of the opening degree of the throttle valve in a state where there is no air flow in the intake passage, the closing spring is not mounted, and the electric motor is not energized.

In accordance with the first aspect, the torque applied to the throttle valve is T(θ)+S(θ), which is the sum of the vacuum-induced torque T(θ) (≥0) acting in the closing direction and the elastic torque S(θ) (≥0) also acting in the closing direction. No torque is applied in the opening direction. Therefore, as long as G>T(θ)+S(θ) is satisfied in the closing direction, the opening degree of the throttle valve at the point when power to the electric motor is stopped can be stably maintained, reducing power consumption. Furthermore, if no closing spring is provided, backlash in the gears between the electric motor and the throttle valve may cause ratting or similar mechanical disturbances. As a result, hunting may occur, in which the throttle valve repeatedly performs small rotations in the opening and closing direction. Such behavior is undesirable. However, in the first aspect, since the closing spring is provided to bias the throttle valve toward the closing direction, gear backlash is eliminated, preventing hunting and enabling stable maintenance of the throttle valve opening.

A second aspect of this disclosure is an electric throttle device provided in an intake passage of a naturally aspirated gasoline engine. The electric throttle device comprises a throttle valve, an opening spring that applies a torque to the throttle valve in an opening direction depending on an opening degree from a fully closed position, and an electric motor that rotates the throttle valve between the fully closed position and a fully open position. The opening spring satisfies G>T(θ)−S(θ) in a closing direction of the throttle valve and |−G|>|T(θ)−S(θ)|in the opening direction. T(θ) is a vacuum-induced torque acting on the throttle valve at the opening degree θ in the closing direction. The vacuum-induced torque is produced by a negative pressure generated when the naturally aspirated gasoline engine is assumed to operate at its maximum intake air flow. −S(θ) is an elastic torque acting on the throttle valve at the opening degree θ in the opening direction. The elastic torque is generated by the opening spring. G is a closing-side holding limit torque in the closing direction. −G is an opening-side holding limit torque in the opening direction. The closing-side holding limit torque and the opening-side holding limit torque are minimum torques capable of rotating the throttle valve, when stationary, regardless of the opening degree of the throttle valve in a state where there is no air flow in the intake passage, the opening spring is not mounted, and the electric motor is not energized.

In accordance with the second aspect, the torque applied to the throttle valve is the sum of the vacuum-induced torque T(θ) (≥0) acting in the closing direction and the elastic torque −S(θ) (≤0) acting in the opening direction. When the resultant torque T(θ)−S(θ) is non-negative (≥0), a closing-direction torque is applied to the throttle valve. When T(θ)−S(θ) is negative (<0), an opening-direction torque is applied to the throttle valve. Therefore, if G>T(θ)−S(θ) is satisfied in the closing direction and |−-G|>|T(θ)−S(θ)|is satisfied in the opening direction, the opening degree of the throttle valve can be stably maintained at that point when power to the electric motor is shut off. Accordingly, power consumption can be reduced. Furthermore, if no opening spring is provided, backlash in the gears between the electric motor and the throttle valve may cause ratting or similar mechanical disturbances. As a result, hunting may occur, in which the throttle valve repeatedly performs small rotations in both the opening and closing directions. Such behavior is undesirable. However, in the second aspect, since the opening spring is provided to bias the valve toward the opening direction, gear backlash is eliminated, preventing hunting and enabling stable maintenance of the throttle valve opening.

A third aspect of this disclosure is the electric throttle device of the first or second aspect, wherein the naturally aspirated gasoline engine is intended for use in a generator.

In accordance with the third aspect, since the opening degree of the throttle valve remains substantially constant during engine operation in a gasoline engine for a generator, the opening degree of the throttle valve can be stably maintained at that point when power supply to the electric throttle device is shut off. As a result, power consumption can be reduced.

What is claimed is:

1. An electric throttle device configured to be provided in an intake passage of a naturally aspirated gasoline engine, comprising:
a throttle body including a bore wall portion defining the intake passage;
a throttle valve fixed to a valve shaft rotatably supported by the throttle body;
a closing spring configured to apply a torque to the throttle valve in a closing direction depending on an opening degree θ of the throttle valve from a fully closed position; and
an electric motor configured to rotate the throttle valve between the fully closed position and a fully open position via a reduction gear mechanism,
wherein the closing spring satisfies G>T(θ)+S(θ) in the closing direction,
wherein T(θ) is a vacuum-induced torque acting on the throttle valve at the opening degree θ in the closing direction, the vacuum-induced torque being produced by a negative pressure generated when the naturally aspirated gasoline engine is assumed to operate at a maximum intake air flow,
wherein S(θ) is an elastic torque acting on the throttle valve at the opening degree θ in the closing direction, the elastic torque being generated by the closing spring, and
wherein G is a closing-side holding limit torque that is a minimum torque capable of rotating the throttle valve, when stationary, in the closing direction regardless of the opening degree of the throttle valve in a state where there is no air flow in the intake passage, the closing spring is not provided, and the electric motor is not energized.

2. The electric throttle device of claim 1, wherein the naturally aspirated gasoline engine is intended for use in a generator.

3. An electric throttle device configured to be provided in an intake passage of a naturally aspirated gasoline engine, comprising:
a throttle body including a bore wall portion defining the intake passage;
a throttle valve fixed to a valve shaft rotatably supported by the throttle body;
an opening spring configured to apply a torque to the throttle valve in an opening direction depending on an opening degree θ of the throttle valve from a fully closed position; and
an electric motor configured to rotate the throttle valve between the fully closed position and a fully open position via a reduction gear mechanism,
wherein the opening spring satisfies G>T(θ)−S(θ) in a closing direction of the throttle valve and |−G|>|T(θ)−S(θ)|in the opening direction,
wherein T(θ) is a vacuum-induced torque acting on the throttle valve at the opening degree θ in the closing direction, the vacuum-induced torque being produced by a negative pressure generated when the naturally aspirated gasoline engine is assumed to operate at a maximum intake air flow,
wherein −S(θ) is an elastic torque acting on the throttle valve at the opening degree θ in the opening direction, the elastic torque being generated by the opening spring, and
wherein G and −G are a closing-side holding limit torque in the closing direction and an opening-side holding limit torque in the opening direction, respectively, the closing-side holding limit torque and opening-side holding limit torque being minimum torques capable of rotating the throttle valve, when stationary, regardless of the opening degree of the throttle valve in a state where there is no air flow in the intake passage, the opening spring is not provided, and the electric motor is not energized.

4. The electric throttle device of claim 3, wherein the naturally aspirated gasoline engine is intended for use in a generator.
